(19) United States
(12) Patent Application Publication
(10) Pub. No.: US 2009/0222609 A1
(43) Pub. Date: Sep. 3, 2009

(54) APPARATUS FOR AUTOMATICALLY REGULATING SYSTEM ID OF MOTHERBOARD OF SERVER AND SERVER HAVING THE SAME

(75) Inventors: Hai-Yi Ji, Shanghai City (CN); Shih-Hao Liu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/052,408

(22) Filed: Mar. 20, 2008

(30) Foreign Application Priority Data
Feb. 29, 2008 (TW) 97106993

(51) Int. Cl. G06F 13/00

(52) U.S. Cl. 710/302

(57) ABSTRACT

An apparatus for automatically regulating a system ID of a motherboard of a server and a server having the same are provided. Under a condition that when a rack server is applied to different server systems, the rack server requires different riser cards, while a tower server does not require any riser card, whenever a corresponding riser card or a device card is inserted into the slot of the motherboard of the server, the present invention can automatically regulate a system ID of a motherboard of a server by designing the motherboard of the server compatible with a plurality of server systems as retained at a same status, i.e., retaining the any status configured on the motherboard unchanged.

### CROSS-REFERENCE TO RELATED APPLICATION

This application claims the priority benefit of Taiwan application serial no. 197106993, filed on Feb. 29, 2008. The entirety the above-mentioned patent application is hereby incorporated by reference herein and made a part of specification.

### BACKGROUND OF THE INVENTION

1. Field of the Invention

The present invention generally relates to a server, and more particularly, to an apparatus for automatically regulating a system ID of a motherboard of a server and a server thereof.

2. Description of Related Art

Servers are now broadly used by many enterprises. They are not only incorporated with the application of internet and telecommunication, but even deeply involved in people's daily life. For example, current financing, economic, net banking, online credit card, require an extremely, high security guarantee to protect the information from being unauthorized accessed, which demands the server thereof having a very strong calculating-capability.

In general, there are currently many kinds of servers provided in the market, in which rack servers and tower servers are normal. Rack servers generally can be divided into 1U, 2U and 4U server systems, while tower servers generally can be divided into 5U and 6U server systems. In order to enhance the usability of the motherboard of a server product, it is desired to develop the motherboard of the server to be compatible with different server systems, for example being compatible with 1U, 2U server systems of rack server, and 5U server system of tower server.

In order to allow the motherboard of the server compatible with different kinds of server systems to learn what kind of server system (e.g., one of the 1U, 2U, and 5U server systems) it is being applied to, it is a conventional approach to introduce a 2-bit system ID on the motherboard of the server. Therefore, what kind of server system that the motherboard of the server compatible with different kinds of server systems is being applied to can be learnt by varying a status of the 2-bit system ID.

For example, if the 2-bit system IDs are respectively 00 and 01, it indicates that the motherboard of the server compatible with different kinds of server systems is being applied to a 1U and 2U server system of rack server. As such, when the motherboard learns that the 2-bit system ID is 00, it also learns that it is being applied to a 1U server system of rack server. Similarly, when the motherboard learns that the 2-bit system ID is 01, it also learns that it is being applied to a 2U server system of rack server.

It is well known to those skilled in the art that such a 2-bit system ID is usually stored in a system chip, e.g., south bridge chip, of the motherboard of the server, or a register of software. Currently, there are generally three methods for varying the 2-bit system ID of the motherboard of the server, which including below:

1. disposing resistors on the motherboard of the server, and directly setting the system ID by pulling high or pulling low with the resistors, by which the status of the 2-bit system ID of the system chip of the motherboard of the server can be varied;

2. varying the status of the 2-bit system ID of the system chip of the motherboard of the server by refreshing the software; and

3. disposing a dual in-line package (DIP) switch on the motherboard of the server, and setting the system ID by the DIP switch, and thus varying the status of the 2-bit system ID of the system chip of the motherboard of the server.

Unfortunately, all of the three methods manually vary the status of the 2-bit system ID of the system chip of the motherboard of the server, which sometimes causes misoperation. Further, all of these three methods have varied the 2-bit system ID of the system chip of the motherboard of the server, so that motherboards of servers for different server systems must be sorted before leaving factory, which consumes much labor power. As such, when used for different server systems, the motherboard of the server compatible with different kinds of server systems can not be adaptively taken for use, and thus the convenience of application of which is much restricted.

### SUMMARY OF THE INVENTION

Accordingly, the present invention is directed to an apparatus for automatically regulating a system ID of a motherboard of a server, and a server having the same. The present invention is adapted for automatically regulating the system ID of the motherboard of the server, so as to not only avoid misoperation introduced by manual operation, but also allow a motherboard of the server compatible with different kinds of server systems to be adaptively taken for use when used for different server systems, and thus the convenience of application of which is not restricted.

The present invention provides an apparatus for automatically regulating a system ID of a motherboard of a server. The apparatus includes a slot, a riser card, and a system chip. The slot is disposed on the motherboard, and has a first identification pin and a second identification pin. The first identification pin and the second identification pin are coupled to a system power source. The riser card has a first reserved pin and a second reserved pin. The first reserved pin and the second reserved pin are either coupled to a grounding level or retained at a floating status. The system chip is disposed on the motherboard, and coupled to the slot, for storing the system ID of the motherboard.

According to an embodiment of the present invention, when the riser card is inserted into the slot through an interface, the first identification pin is coupled to the first reserved pin, and the second identification pin is coupled to the second reserved pin, so that the system chip can automatically regulate the system ID of the motherboard stored in the system chip according to voltage levels at the first identification pin and the second identification pin.

According to an embodiment of the present invention, the system chip includes a first general purpose input/output (GPIO) pin, a second GPIO pin, a first register, and a second register. The first GPIO pin is coupled to the first identification pin. The second GPIO pin is coupled to the second identification pin. The first register is adapted for storing data correspondingly received by the first GPIO pin. The second register is adapted for storing data correspondingly received by the second GPIO pin. The data stored respectively in the first and the second registers constitute the system ID of the motherboard.

According to an embodiment of the present invention, when the first reserved pin and the second reserved pin are all coupled to the grounding level, the data stored in the first register and the second register are 0 and 0 respectively, so that the system ID of the motherboard is 00. In such a way, there is a basic input/output system (BIOS) disposed on the motherboard. The BIOS is adapted to learn that the server is a 1U server system of rack server by reading the data stored in the first register and the second register.

According to an embodiment of the present invention, when the first reserved pin is retained at the floating status, and the second reserved pin is coupled to the grounding level, the data stored in the first register is 1, and the data stored in the second register is 0, so that the system ID of the motherboard is 01. In such a way, there is a basic input/output system (BIOS) disposed on the motherboard. The BIOS is adapted to learn that the server is a 2U server system of rack server by reading the data stored in the first register and the second register.

According to an embodiment of the present invention, when the first reserved pin is coupled to the grounding level, and the second reserved pin is retained at the floating status, the data stored in the first register is 0, and the data stored in the second register is 1, so that the system ID of the motherboard is 10. In such a way, there is a basic input/output system (BIOS) disposed on the motherboard. The BIOS is adapted to learn that the server is a 4U server system of rack server by reading the data stored in the first register and the second register.

According to an embodiment of the present invention, the apparatus further includes a device card. When the device card is inserted into the slot through the interface, the data stored in the first register and the second register are 1 and 1 respectively, so that the system ID of the motherboard is 11. In such a way, there is a basic input/output system (BIOS) disposed on the motherboard. The BIOS is adapted to learn that the server is a 5U or 6U server system of tower server by reading the data stored in the first register and the second register.

According to the foregoing embodiments, the first identification pin and the second identification pin are respectively coupled to the system power source via a pull high resistor.

According to the foregoing embodiments, when the first reserved pin and the second reserved pin are coupled to the grounding level, the first reserved pin and the second reserved pin are either coupled to the grounding level via a pull low resistor or directly coupled to the grounding level.

According to the foregoing embodiments, the system chip is either a south bridge chip or a board management controller (BMC) chip.

According to the foregoing embodiments, the slot is a peripheral component interconnect express (PCIE) slot, the interface is a PCIE interface, and the riser card is a PCIE riser card.

The present invention is also directed to a server having an apparatus for automatically regulating a system ID of a motherboard of a server.

Under a condition that when a rack server is applied to different server systems, the rack server requires different riser cards, while a tower server does not require any riser card, whenever a corresponding riser card or a device card is inserted into the slot of the motherboard of the server, the present invention can automatically regulate a system ID of a motherboard of a server by designing the motherboard of the server compatible with a plurality of server systems as retained at a same status, i.e., retaining the any status configured on the motherboard unchanged.

Accordingly, the apparatus for automatically regulating a system ID of a motherboard of a server is adapted to not only avoid misoperation introduced by manual operation, but also allow a motherboard of the server compatible with different kinds of server systems to be adaptively taken for use when used for different server systems, and thus the convenience of application of which is not restricted.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system structure diagram of a server 100 according to an embodiment of the present invention.

FIG. 2 is a schematic circuit diagram illustrating a PCIE slot 101e disposed on a motherboard 101.

FIGS. 3A through 3C are schematic diagrams illustrating the design of a PCIE riser card 103 adapted for 1U, 2U and 4U server systems of rack server.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention is provided for automatically regulating a system ID of a motherboard of a server. Characteristics of the present invention will be discussed in detail herebelow.

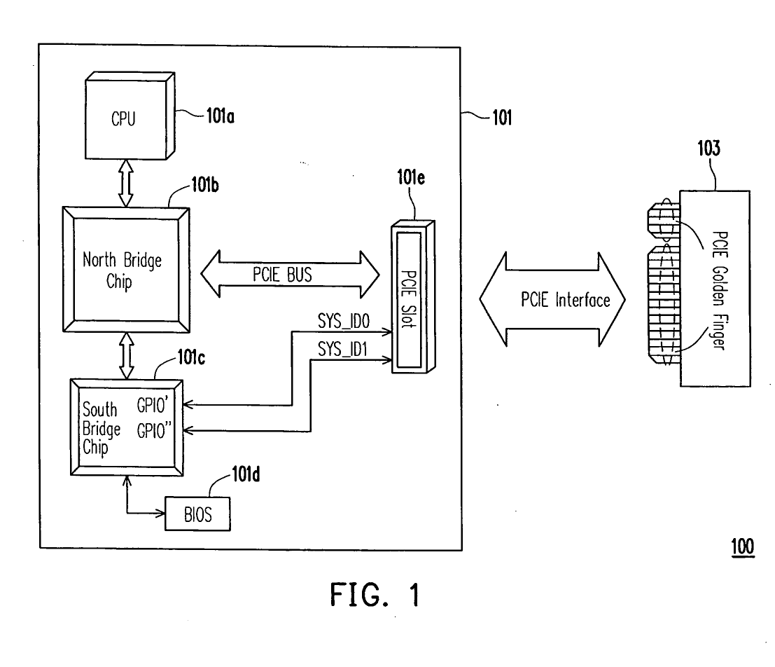

FIG. 1 is a system structure diagram of a server 100 according to an embodiment of the present invention. Referring to FIG. 1, the server 100 includes a motherboard 101, a riser card 103, which is exemplified with a PCIE riser card hereby according to the instant embodiment. The motherboard 101 includes a center processor unit (CPU) 101a, a north bridge chip 101b, a south bridge chip 101c, a basic input output system (BIOS) 101d, and a peripheral component interconnect express (PCIE) slot 101e disposed thereon.

It should be noted that there are also other components disposed on the motherboard 101, for example the north bridge chip 101b should be coupled to a memory module (not shown). However, only those relates to the spirit of the present invention are discussed hereby for the purpose of clear illustration. Further, according to an aspect of the present invention, the apparatus for automatically regulating a system ID SYS_ID0/1 of the motherboard 101 of the server 100 is mainly composed of a system chip, e.g., the south bridge chip 101c, the PCIE riser card 103, and the PCIE slot 101e.

The principle of operation of the present invention which allows the present invention to automatically regulates the system ID of the motherboard of the server with the corresponding riser card or device card inserted into a slot of the motherboard of the server, and without varying any of the status of the motherboard will be discussed in reference with the drawings below for allowing those having ordinary skill in the art to understand the spirit of the present invention.

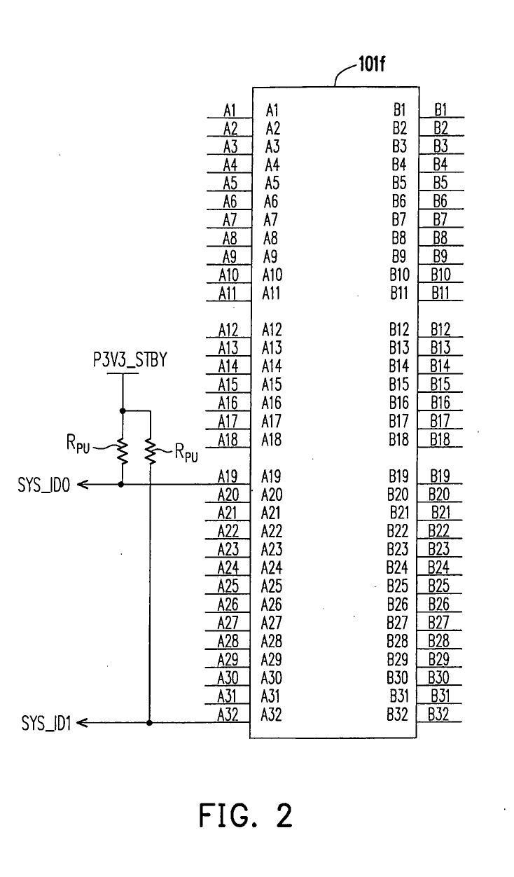

FIG. 2 is a schematic circuit diagram illustrating a PCIE slot 101e disposed on a motherboard 101. Referring to FIGS. 1 and 2 together, the PCIE slot 101e has a first identification pin A19, and a second identification pin A32. The first identification pin A19 and the second identification pin A32 are respectively coupled to a system power source (e.g., a 3.3V system/backup power source of the motherboard 101) P3V3_STBY via a pull high resistor R_{PU}.

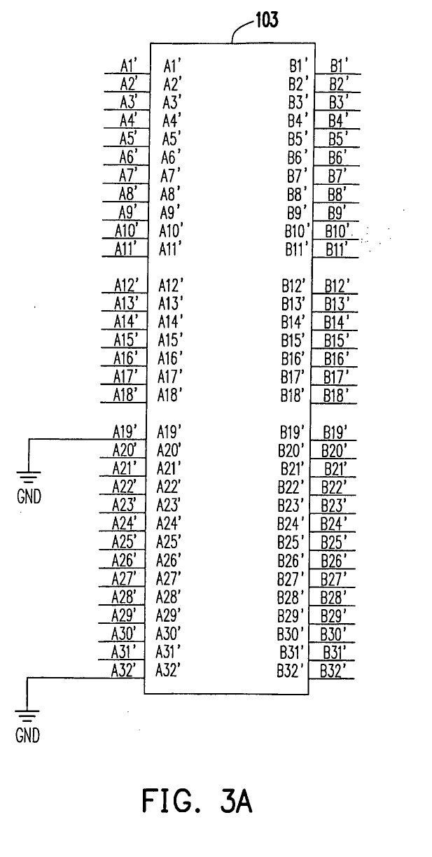

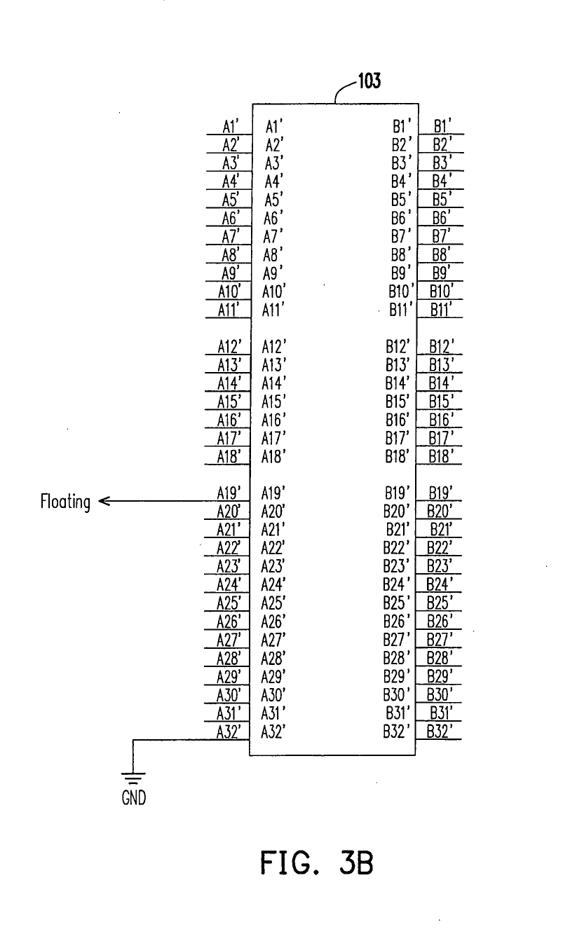

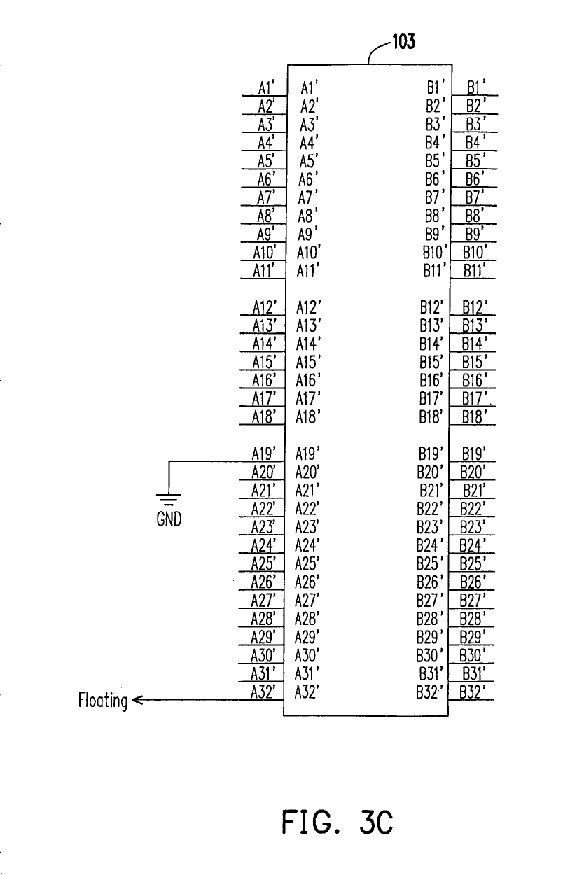

Then, referring to FIG. 3A, there is shown a schematic diagram of a PCIE riser card 103 adapted for a 1U server system of rack server. Referring to FIGS. 1 through 3A, the PCIE riser card 103 includes golden fingers marked with A1′ through A32′, and B1′ through B32′ in FIG. 3A. The PCIE riser card 103 has a first reserved pin A19′ and a second reserved pin A32′. The first reserved pin A19′ and the second reserved pin A32′ are either coupled to a grounding level GND via a pull low resistor (not shown) or directly coupled to the grounding level GND.

Then, referring to FIG. 3B, there is shown a schematic diagram of a PCIE riser card 103 adapted for a 2U server system of rack server. Referring to FIGS. 1 through 3B, the PCIE riser card 103 includes golden fingers marked with A1′ through A32′, and B1′ through B32′ in FIG. 3A. The PCIE riser card 103 has a first reserved pin A19′ and a second reserved pin A32′. The first reserved pin A19′ is retained at a floating status, and the second reserved pin A32′ is either coupled to a grounding level GND via a pull low resistor (not shown) or directly coupled to the grounding level GND.

Finally, referring to FIG. 3C, there is shown a schematic diagram of a PCIE riser card 103 adapted for a 4U server system of rack server. Referring to FIGS. 1 through 3C, the PCIE riser card 103 includes golden fingers marked with A1′ through A32′, and B1′ through B32′ in FIG. 3A. The PCIE riser card 103 has a first reserved pin A19′ and a second reserved pin A32′. The first reserved pin A19′ is either coupled to a grounding level GND via a pull low resistor (not shown) or directly coupled to the grounding level GND. The second reserved pin A32′ is retained at a floating status.

It should be noted that because the first reserved pin A19′ and the second reserved pin A32′ are defined by the PCIE Express interface as reserved pins, the present invention is capable of designing the PCIE riser card 103 corresponding to different server systems of rack server.

Referring to FIGS. 1 through 3 C, the south bridge chip 101c is coupled to the PCIE slot 101e, for storing the system ID SYS_ID0/1 of the motherboard 101. According to the embodiment, when the PCIE riser card 103 is inserted into the PCIE slot 101e through an interface, i.e., PCIE interface, the first identification pin A19 of the PCIE slot 101e is coupled to the first reserved pin A19′, and the second identification pin A32 of the PCIE slot 101e is coupled to the second reserved pin A32, so that the south bridge chip 101c can automatically regulate the system ID SYS_ID0/1 of the motherboard 101 according to voltage levels at the first identification pin A19 and the second identification pin A32 of the PCIE slot 101e.

According to an embodiment of the present invention, the south bridge chip 101c includes a first general purpose input/output (GPIO) pin GPIO′, a second GPIO pin GPIO″, a first register (not shown), and a second register (not shown). The first GPIO pin GPIO′ is coupled to the first identification pin A19 of the PCIE slot 101e. The second GPIO pin GPIO″ is coupled to the second identification pin A32 of the PCIE slot 101e.

The first register is adapted for storing data correspondingly received by the first GPIO pin GPIO′. The second register is adapted for storing data correspondingly received by the second GPIO pin GPIO″. The data stored respectively in the first and the second registers constitute the system ID SYS_ID0/1 of the motherboard 101.

For the convenience of illustration, it is presumed that the system ID SYS_ID0/1 is a 2-bit system ID, and when the 2-bit system ID is 00, 01, 10, or 11, it indicates that the motherboard 101 of server 100 compatible with a plurality of server systems is being applied to a 1U, 2U, 4U server system of rack server or a 5U or 6U server system of tower server.

As presumed above, when the PCIE riser card 103 of FIG. 3A is inserted into the PCIE slot 101e, because both of the first reserved pin A19′ and the second reserved pin A32′ are coupled to the grounding level GND, data stored in the first register and the second register of the south bridge chip 101c are 0 and 0 respectively. And therefore, the system ID SYS_ID0/1 of the motherboard 101 is 00. In such a way, the BIOS 101d is capable of learning that the server 100 is a 1U server system of rack server by reading the data stored in the first and the second registers of the south bridge chip 101c.

In addition, when the PCIE riser card 103 of FIG. 3B is inserted into the PCIE slot 101e, because both of the first reserved pin A19′ is retained at a floating status, and the second reserved pin A32′ is coupled to the grounding level GND, data stored in the first register and the second register of the south bridge chip 101c are 1 and 0 respectively. And therefore, the system ID SYS_ID0/1 of the motherboard 101 is 01. In such a way, the BIOS 101d is capable of learning that the server 100 is a 2U server system of rack server by reading the data stored in the first and the second registers of the south bridge chip 101c.

Furthermore, when the PCIE riser card 103 of FIG. 3C is inserted into the PCIE slot 101e, because both of the first reserved pin A19′ is coupled to the grounding level GND, and the second reserved pin A32′ is retained at a floating status, data stored in the first register and the second register of the south bridge chip 101c are 0 and 1 respectively. And therefore, the system ID SYS_ID0/1 of the motherboard 101 is 10. In such a way, the BIOS 101d is capable of learning that the server 100 is a 4U server system of rack server by reading the data stored in the first and the second registers of the south bridge chip 101c.

According to the foregoing embodiments, it can be understood that the present invention requires only the insertion of a corresponding PCIE riser card 103 into the PCIE slot 101e of the motherboard 101 of the server 100 for achieving automatic regulation of the system ID SYS_ID0/1 of the motherboard 101 of the server 100. Further, the PCIE riser card 103 may also transmit data with the north bridge chip 101b, the south bridge chip 101c, and the CPU 101a via a PCIE bus.

Besides, in order allow the motherboard 101 to be also compatible with the 5U or 6U server system of tower server, the apparatus for automatically regulating the system ID SYS_ID0/1 of a motherboard 101 of a server 100 further includes a device card (not shown). It should be noted that because the tower server does not require a PCIE riser card 103 to be equipped to the PCIE slot 101e. As such, the tower server allows the device card directly inserted into the PCIE slot 101e.

Therefore, because a standard device card does not function upon the first identification pin A19 and the second identification pin A32, when the device card is inserted into the PCIE slot 101e via the PCIE interface, the data stored in the first register and the second register of the south bridge chip 101c are respectively 1 and 1. And therefore, the system ID SYS_ID0/1 of the motherboard 101 is 11. In such a way, the BIOS 101d is capable of learning that the server 100 is a 5U server system or a 6U server system of tower server by reading the data stored in the first and the second registers of the south bridge chip 101c.

Similarly, according to the foregoing embodiments, it can be understood that if only a device card 103 is inserted into the PCIE slot 101 e of the motherboard 101 of the server 100, the present invention also can automatically regulate the system ID SYS_ID0/1 of the motherboard 101 of the server 100.

Of course, the foregoing embodiments are given for exemplification without restricting the scope of the present invention. Specifically, the system chip is not restricted to be a south bridge chip 101d as taught above. On the contrary, any system chip having a GPIO pin, such as a board management controller (BMC) chip can be used to replace the south bridge chip 101d, or executing the similar function as discussed in the above embodiments.

In general, under a condition that when a rack server is applied to different server systems, the rack server requires different riser cards, while a tower server does not require any riser card, whenever a corresponding riser card or a device card is inserted into the slot of the motherboard of the server, the present invention can automatically regulate a system ID of a motherboard of a server by designing the motherboard of the server compatible with a plurality of server systems as retained at a same status, i.e., retaining the any status configured on the motherboard unchanged.

Accordingly, the apparatus for automatically regulating a system ID of a motherboard of a server is adapted to not only avoid misoperation introduced by manual operation, but also allow a motherboard of the server compatible with different kinds of server systems to be adaptively taken for use when used for different server systems, and thus the convenience of application of which is not restricted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for automatically regulating a system ID of a motherboard of a server, comprising:
a slot, disposed on the motherboard, and having a first identification pin and a second identification pin, wherein the first identification pin and the second identification pin are coupled to a system power source;
a riser card having a first reserved pin and a second reserved pin, wherein the first reserved pin and the second reserved pin are either coupled to a grounding level or retained at a floating status; and
a system chip, disposed on the motherboard, and coupled to the slot, for storing the system ID of the motherboard;
wherein when the riser card is inserted into the slot through an interface, the first identification pin is coupled to the first reserved pin, and the second identification pin is coupled to the second reserved pin, so that the system chip automatically regulates the system ID of the motherboard stored in the system chip according to voltage levels at the first identification pin and the second identification pin.

2. The apparatus according to claim 1, wherein the system chip comprises:
a first general purpose input/output (GPIO) pin, coupled to the first identification pin;
a second GPIO pin, coupled to the second identification pin;
a first register, adapted for storing data correspondingly received by the first GPIO pin; and
a second register, adapted for storing data correspondingly received by the second GPIO pin;
wherein the data stored respectively in the first and the second registers constitute the system ID of the motherboard.

3. The apparatus according to claim 2, wherein when the first reserved pin and the second reserved pin are all coupled to the grounding level, the data stored in the first register and the second register are 0 and 0 respectively, so that the system ID of the motherboard is 00.

4. The apparatus according to claim 3, wherein there is a basic input/output system (BIOS) disposed on the motherboard, the BIOS is being adapted to learn that the server is a 1U server system of rack server by reading the data stored in the first register and the second-register.

5. The apparatus according to claim 2, wherein when the first reserved pin is retained at the floating status and the second reserved pin is coupled to the grounding level, the data stored in the first register is 1, and the data stored in the second register is 0, so that the system ID of the motherboard is 01.

6. The apparatus according to claim 5, wherein there is a basic input/output system (BIOS) disposed on the motherboard, and the BIOS is being adapted to learn that the server is a 2U server system of rack server by reading the data stored in the first register and the second register.

7. The apparatus according to claim 2, wherein when the first reserved pin is coupled to the grounding level and the second reserved pin is retained at the floating status, the data stored in the first register is 0, and the data stored in the second register is 1, so that the system ID of the motherboard is 10.

8. The apparatus according to claim 7, wherein there is a basic input/output system (BIOS) disposed on the motherboard, and the BIOS is being adapted to learn that the server is a 4U server system of rack server by reading the data stored in the first register and the second register.

9. The apparatus according to claim 2 further comprising a device card.

10. The apparatus according to claim 9, wherein when the device card is inserted into the slot through the interface, the data stored in the first register and the second register are 1 and 1 respectively, so that the system ID of the motherboard is 11.

11. The apparatus according to claim 10, wherein there is a basic input/output system (BIOS) disposed on the motherboard, and the BIOS is being adapted to learn that the server is a 5U server system or a 6U server system of tower server by reading the data stored in the first register and the second register.

12. The apparatus according to claim 1, wherein the first identification pin and the second identification pin are respectively coupled to the system power source via a pull high resistor.

13. The apparatus according to claim 1, wherein when the first reserved pin and the second reserved pin are coupled to the grounding level, the first reserved pin and the second reserved pin are either coupled to the grounding level via a pull low resistor or directly coupled to the grounding level.

14. The apparatus according to claim 1, wherein the system chip is either a south bridge chip or a board management controller (BMC) chip.

15. The apparatus according to claim 1, wherein the slot is a peripheral component interconnect express (PCIE) slot, the interface is a PCIE interface, and the riser card is a PCIE riser card.

16. A server comprising an apparatus for automatically regulating a system ID of a motherboard of a server as claimed in claim 1.
